(19) United States
(12) Patent Application Publication
(10) Pub. No.: US 2008/0182163 A1
(43) Pub. Date: Jul. 31, 2008

(54) BATTERY LOADING AND UNLOADING STRUCTURE

(75) Inventors: Xunhua Xiao, Shenzhen (CN); Guoying Chen, Shenzhen (CN); Zuomeng Xie, Shenzhen (CN)

Correspondence Address: MINDRAY C/O STOEL RIVES LLP, 201 S. MAIN STREET, SUITE 1100, SALT LAKE CITY, UT, 84111, US

(73) Assignee: SHENZHEN MINDRAY BIO-MEDICAL ELECTRONICS CO., LTD., Shenzhen (CN)

(21) Appl. No.: 11/966,664

(22) Filed: Dec. 28, 2007

(30) Foreign Application Priority Data
Jan. 26, 2007 (CN) 200710073123.8

(51) Int. Cl. H01M 2/10

(52) U.S. Cl. 429/100

(57) ABSTRACT

A battery loading and unloading structure is disclosed, including a main body having a battery receiver defined by a bottom and sidewall, the bottom being provided with a resilient ejector, the sidewall being provided with a battery retainer that is located in a moving track of an engaging member and laterally moves upon an applied force. The structure further includes a resetting member to reset the battery retainer. When a battery is loaded, the battery retainer automatically moves laterally to avoid blocking the engaging member in response to the force applied thereon, and resets to catch the battery after the battery has been loaded into place. When the battery is unloaded, the resilient ejector can eject the battery by moving the battery retainer to the sides to disengage from the engaging member.

### RELATED APPLICATIONS

The present application claims priority to Chinese Patent Application No. 200710073123.8, filed on Jan. 26, 2007, and entitled “Battery Loading and Unloading Structure,” the disclosure of which is fully incorporated herein by reference.

### TECHNICAL FIELD

The present disclosure relates to a battery loading and unloading structure.

### SUMMARY

A battery loading and unloading structure for a portable electronic device, such as a portable color Doppler ultrasonic apparatus, is disclosed.

### BRIEF DESCRIPTION OF THE DRAWINGS

FIG. 1 is a back perspective view of a battery loading and unloading structure of one embodiment (not including a battery retainer actuating plate).

FIG. 2 is a front perspective view of the battery loading and unloading structure of one embodiment.

FIG. 3 is a back perspective view of the battery loading and unloading structure of one embodiment.

FIG. 4 is an exploded perspective view of the battery loading and unloading structure of one embodiment.

FIG. 5 is a schematic view of the battery loading and unloading structure of one embodiment with a battery being loaded into place.

FIG. 6 is a schematic view of the battery loading and unloading structure of one embodiment with a battery already loaded into place.

FIG. 7 is a schematic view of unloading a battery.

FIG. 8 is a sectional view of the battery loading and unloading structure with a battery already loaded.

### DETAILED DESCRIPTION OF PREFERRED EMBODIMENTS

Various portable electronic devices, one example of which is a portable color Doppler ultrasonic apparatus, use a triangular retainer to load and unload batteries. However, this mechanism is only suitable for use in places with a large enough space for an operator to perform a large moving stroke. When space is limited, it is necessary to shorten the stroke or make a larger engaging member, and a much stronger pulling force is demanded of the operator. Furthermore, it is not easy to remove the battery, because the limited space restricts the height to which the battery can be released.

The present disclosure provides a battery loading and unloading structure that is easy to operate, has a smaller moving stroke, and demands less of the operator's pulling force. In one configuration, the battery loading and unloading structure includes a main body having a battery receiver defined by a bottom and sidewall of the main body, wherein the bottom has a resilient ejector and the sidewall has a battery retainer, which is located in a moving track of an engaging member and moves laterally upon an applied force, and a resetting member to reset the battery retainer.

In one embodiment, the battery retainer has an inclined guide surface, and the resetting member is a resilient member that biases against the sidewall on one end and the battery retainer on the other end. The battery retainer may have a mounting post with the resilient piece telescoped thereon.

A battery retainer plate may be installed on the sidewall and below the battery retainer to cover the resilient member. A battery retainer actuating plate may be installed above the battery retainer, such that the battery retainer actuating plate cooperates with the battery retainer.

In one embodiment, the battery retainer actuating plate has a pawl projecting downwardly and a corresponding recess into which the pawl can be received. The elastomer may be an elastic sheet extending cantileveredly and slopingly from the bottom of the main body.

In one implementation, when a battery is loaded, the battery retainer automatically moves laterally to avoid blocking the engaging member in response to the force applied thereon, and resets to catch the battery after the battery has been loaded in place. When the battery is unloaded, the resilient ejector may eject the battery by moving the battery retainer to the sides to disengage from the engaging member. Thus, the battery retainer's sliding stroke is small due to the battery being resiliently ejected, and the battery's engaging member has a smaller dimension. The disclosed battery loading and unloading structure therefore reduces the demand in the operator's pulling force, and facilitates the loading and unloading of batteries in a limited space.

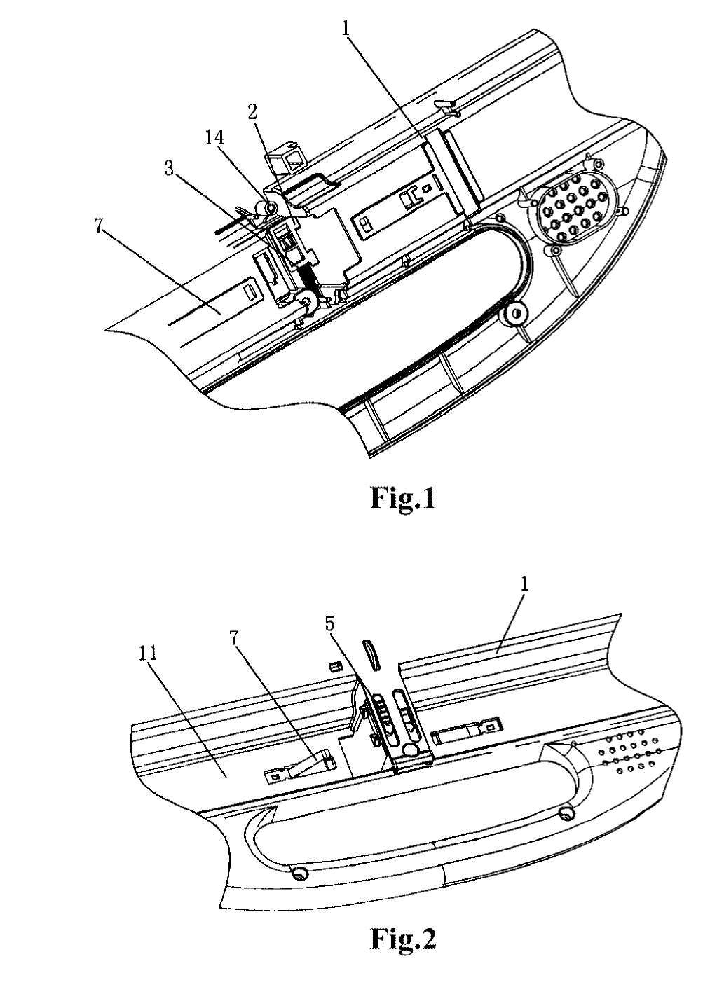

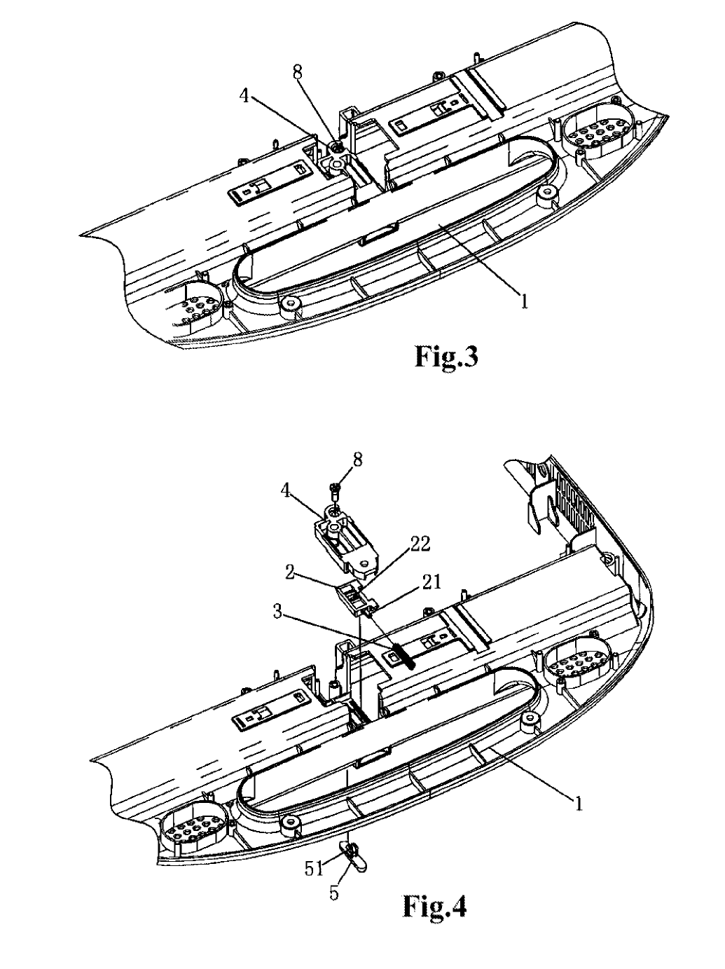

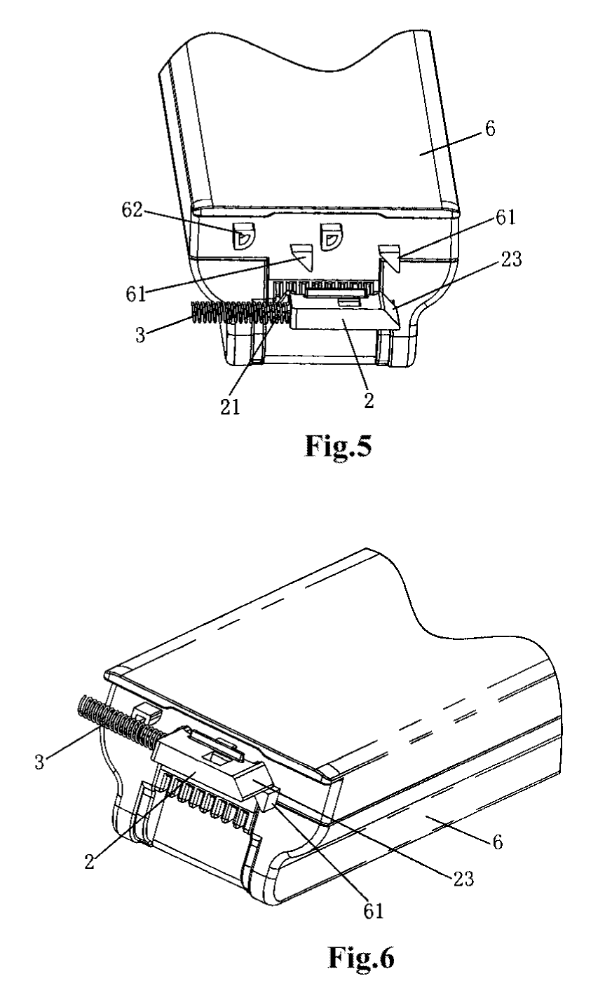

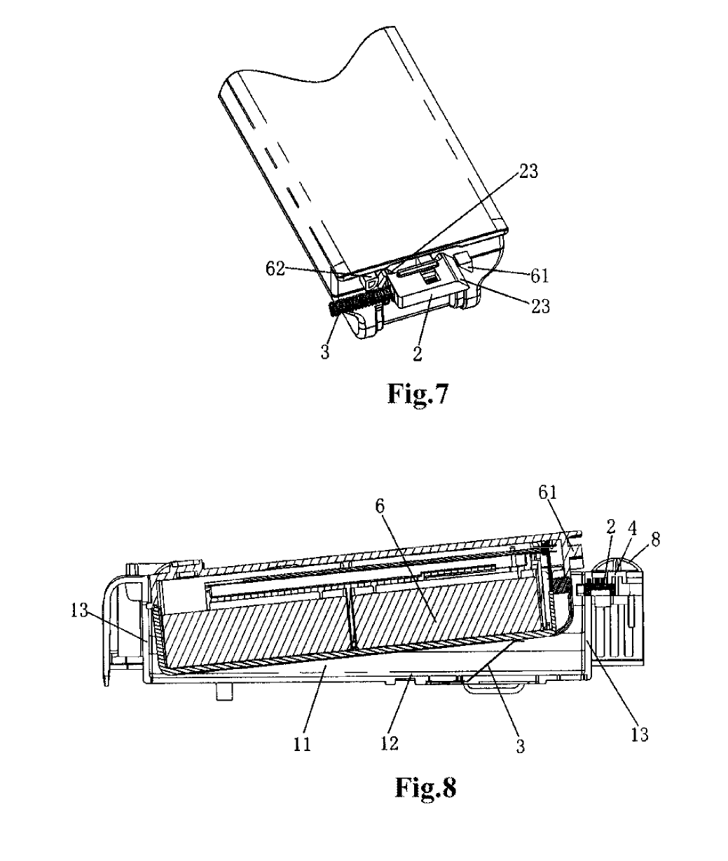

Now referring to FIGS. 1 through 8, the battery loading and unloading structure includes, in one embodiment, a main body 1, a battery retainer 2, and a resetting member 3. The main body 1 includes a battery receiver 11 for receiving a battery 6, the battery receiver 11 being defined by a bottom 12 and a sidewall 13. The battery retainer 2 is located in the moving track of an engaging member 61, and can move laterally when pressed by the engaging member 61. The resetting member 3 is used for resetting the battery retainer 2.

In one embodiment, the bottom 12 of the main body 1 has a resilient ejector 7, which automatically ejects the battery 6, and may, for example, take the form of an elastic sheet 7 extending cantileveredly and slopingly upward from the bottom 12. The battery retainer 2 is horizontally mounted on the sidewall 13 of the main body and has an inclined guide surface 23 at a position corresponding to the engaging member 61. The guide surface 23 is located in the moving track of the engaging member 61 and at least partially extends into the battery receiver 11. The guide surface 23 extends slopingly and downwardly in the direction of the loading battery, thereby forming an acute angle relative to the horizontal plane. Because the battery has two or more (e.g., three or four) engaging members 61, which may take the form of a triangular shape, there accordingly should be two or more guide surfaces 23 as well, each of which has the same sloping direction in one embodiment.

Moreover, the rake of each guide surface 23 may match with that of respective engaging member 61, such that the guide surfaces 23 of the battery retainer 2 can slide against the engaging member 61. However, persons skilled in the art should understand that the engaging member 61 may take any other appropriate shape in addition to said triangular shape, provided that it can realize the expected functions set forth in the present disclosure. The end face of the battery retainer 2 extends horizontally from a mounting post 21.

The resetting member 3 may be an elastic member 3 (e.g., a spring), which is horizontally telescoped on the mounting post 21 and biases against the sidewall 13 of the main body and at the battery retainer 2, respectively. When a battery is being loaded, the force applied on the battery retainer 2 is relatively larger. Therefore, to prevent the elastic piece 3 from jumping out, a battery retainer plate 4 is installed below the battery retainer 2. The battery retainer plate 4 is secured to a post 14 of the main body sidewall via a screw 8, and covers the battery retainer 2 and the elastic member 3. To facilitate snapping the battery retainer 2, a battery retainer actuating plate 5 is installed on the sidewall 13 of the main body above the battery retainer 2. The battery retainer actuating plate 5 has a catch pawl 51 projecting downwardly. Corresponding to the catch pawl 51, a recess 22 is arranged on the battery retainer 2 such that the catch pawl 51 may be received into the battery retainer 2, thereby effecting the cooperation of the battery retainer 2 and the battery retainer actuating plate 5.

The battery loading and unloading structure may operate as follows. When a battery is loaded, a slight force may be sufficient to press down the battery due to gravity. In one embodiment, the two or more engaging members 61 arranged on the sidewall of the battery 6 thereby contact the two or more guide surfaces 23 of the battery retainer 2. In response to the pressure applied by the engaging members 61, the battery retainer 2 moves laterally in a horizontal direction (i.e., the guide surface 23 slides against the engaging members 61), and the elastic member 3 is compressed. When the engaging members 61 of the battery disengage from the corresponding guide surfaces 23, the elastic member 3 recovers. To respond to the resilience, the battery retainer 2 moves in an opposite direction to get reset, such that the battery retainer 2 completely retains the engaging members 61 of the battery (at this moment, the elastic sheet 7 is pressed by the battery 6) to prevent the battery 6 from falling off.

When unloading a battery, the battery retainer actuating plate 5 is snapped to cause the battery retainer 2 to slide therewith. Thus the elastic member 3 is compressed. When the battery retainer 2 is pushed so it touches the semicircle positioning clip 62 of the battery, the battery retainer 2 is completely disengaged from the engaging members 61 of the battery, and at the same time the elastic sheet 7 operates to lift the battery 6 upwardly. After the battery is unloaded, the battery retainer actuating plate 5 is released and the elastic member 3 recovers, thereby causing the battery retainer 2 to reset to the initial position. The manner in which the battery is lifted, as described in the embodiments of the disclosure, may shorten the sliding stroke of the battery retainer, whereby the battery retainer may have a smaller dimension and a less strict demand is placed on the operator's pulling force.

In the present embodiment, the battery retainer 2 only moves in the horizontal direction rather than in the vertical direction, thereby avoiding blocking the movement of the engaging member 61, and can automatically, with the aid of the elastic member 3, fasten the battery. The resilient ejector may be an elastomer having resilience, such as an elastic sheet of plastic material, a leaf spring, a spring clip, a spring plate formed by the combination of a coil spring and sheet material, etc., and may be an integral member extending from the bottom of the main body, or a separate member.

The battery loading and unloading structure according to the embodiments of the disclosure may be broadly used for a variety of devices, such as a robotic moving controlled apparatus, medical diagnostic apparatus, automatically controlled apparatus, video editing and producing device, medical imaging system, industrial and scientific apparatus, test meter, electromechanical microscope and visualization system, and computer plotting device, etc.

Those skilled in the art will appreciate that words as used herein, such as “a,” “an,” “one,” and “two,” are illustrative only and should by no means be construed as limiting in scope, and thus may be interpreted to include greater or a smaller numbers.

The embodiments of the disclosure are described above in great detail in conjunction with particular embodiments, but the present invention should not be considered as being limited to these particular embodiments. Those of ordinary skill in the art should understand that various simple modifications or substitutions can be made to these embodiments without departing from the scope of the invention. The scope of the present invention should, therefore, be determined only by the following claims.

What is claimed is:

1. A battery loading and unloading structure, including a main body having a battery receiver defined by a bottom and sidewall of the main body, wherein the bottom is provided with a resilient ejector, and the sidewall is provided with a battery retainer and a resetting member to reset the battery retainer, wherein the battery retainer is located in a moving track of an engaging member of the battery and moves laterally upon an applied force.

2. The battery loading and unloading structure according to claim 1, wherein the battery retainer has a guide surface.

3. The battery loading and unloading structure according to claim 2, wherein the battery retainer has an inclined guide surface.

4. The battery loading and unloading structure according to claim 1, wherein the resetting member is a resilient member that biases against the sidewall on one end and the battery retainer on the other end.

5. The battery loading and unloading structure according to claim 4, wherein the battery retainer is provided with a mounting post on an end face, the resilient piece being telescoped on the mounting post.

6. The battery loading and unloading structure according to claim 4, wherein a battery retainer plate is installed on the sidewall and below the battery retainer to cover the resilient member.

7. The battery loading and unloading structure according to claim 1, wherein a battery retainer actuating plate is installed above the battery retainer, the battery retainer actuating plate being cooperative with the battery retainer.

8. The battery loading and unloading structure according to claim 7, wherein the battery retainer actuating plate is provided with a pawl projecting downwardly and a corresponding recess into which the pawl can be received.

9. The battery loading and unloading structure according to claim 1, wherein the resilient ejector is a resilient elastomer.

10. The battery loading and unloading structure according to claim 9, wherein the resilient ejector is an elastic sheet extending cantileveredly and slopingly from the bottom of the main body.

11. The battery loading and unloading structure according to claim 1, wherein the resilient ejector is selected from the group comprising a leaf spring, a spring clip, and a spring plate.

12. The battery loading and unloading structure according to claim 1, wherein the resilient ejector is integral with the bottom, or is a separated member from the bottom.

13. The battery loading and unloading structure according to claim 2, wherein the resilient ejector is a resilient elastomer.

14. The battery loading and unloading structure according to claim 13, wherein the resilient ejector is an elastic sheet extending cantileveredly and slopingly from the bottom of the main body.

15. The battery loading and unloading structure according to claim 2, wherein the resilient ejector is selected from the group comprising a leaf spring, a spring clip, and a spring plate.

16. The battery loading and unloading structure according to claim 2, wherein the resilient ejector is integral with the bottom, or is a separated member from the bottom.

17. The battery loading and unloading structure according to claim 3, wherein the resilient ejector is a resilient elastomer.

18. The battery loading and unloading structure according to claim 4, wherein the resilient ejector is a resilient elastomer.

19. The battery loading and unloading structure according to claim 5, wherein the resilient ejector is a resilient elastomer.
